(19) United States
(12) Patent Application Publication
(10) Pub. No.: US 2014/0196326 A1
(43) Pub. Date: Jul. 17, 2014

(54) DETACHED AND MOBILE PRODUCT ADVERTISEMENT STAND

(71) Applicant: Salih Turhal, Kizilay, Ankara (TR)

(72) Inventor: Salih Turhal, Kizi Lay (TR)

(21) Appl. No.: 14/122,037

(22) PCT Filed: May 22, 2012
(86) PCT No.: PCT/TR2012/000090

§ 371 Date: Mar. 6, 2014

(30) Foreign Application Priority Data
May 27, 2011 (TR) 2011/02696

(51) Int. Cl. G09F 11/02; A47F 11/04; G09F 21/00; G09F 13/00; G09F 13/16

(52) U.S. Cl. CPC G09F 11/02; G09F 13/005; G09F 13/165; G09F 21/00; A47F 11/04
USPC 40/473; 40/582

(57) ABSTRACT

A model that includes advertisement objects, shopping window advertisement, open air advertisement, closed space advertisement and with the real three dimensional characteristic within the sector of advertisement that is not virtual, including the following parts: main box, plates, the mirror/the reflecting surface, the electronic circuit, the soft (paper fabric) material/Teflon dry grease product, first engine, second engine, the mechanism engine, the metal plate, the battery, and the lighting unit, and the magnet, the metal rod, and the gear engine, the first main gear, the interim gears and the second main gear, and the magnet inside the product, capable of providing the image that a half of a real product is rotating in the air and the other half is being reflected on the mirror the reflective surface in a virtual manner and thus being able to provide the vision that the whole product is rotating on empty space.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention is in respect of a detached and mobile product advertisement stand.

2. Description of Related Art Including Information Disclosed Under 37 CFR 1.97 and 37 CFR 1.98.

In the models that are used presently, there is a technical problem that makes the product rotate from just one point and by making a whole in the reflective surface and for the products with a wider surface (mobile phone, planes, cars, watches, beverage boxes, etc.) due to the scratching sensitivity of the mirror/the reflective surface; it creates a problem by causing a scratch on the mirror/the reflective surface and thereby making the reflective surface visible to the eye

With our invention, the said problems are eliminated.

### SUMMARY OF THE INVENTION

The invention is a model that includes all kinds of advertisement objects, shopping window advertisement, open air advertisement, closed space advertisement and with the real three dimensional characteristic within the sector of advertisement that is not virtual, consisting of a total of 14 parts, possible to interchange all of these parts with the desired dimensions, without the condition of the product to be exhibited to be made of metal or plastic or wood, not having any connections to the reflective surface in comparison to the previous inventions, inside the box being capable of undertaking all of the variations within the whole box and not only being limited to a single point, capable of providing the image that a half of a real product is rotating, in the air and the other half is being reflected on the mirror/the reflective surface in a virtual manner and thus being able to provide the vision that the whole product is rotating on empty space.

### BRIEF DESCRIPTION OF THE SEVERAL VIEWS OF THE DRAWINGS

FIG. 1: the assembled view of the product

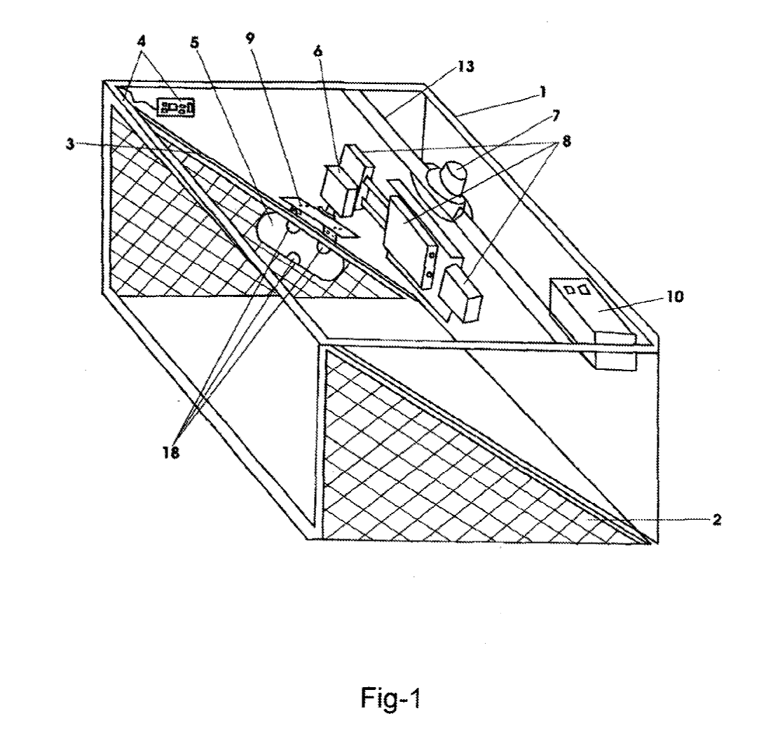

FIG. 2: the engine detail

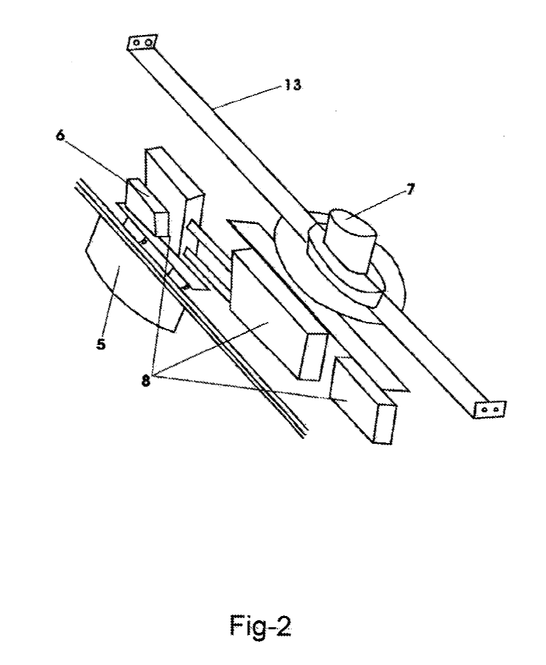

FIG. 3: the disassembled view of the product

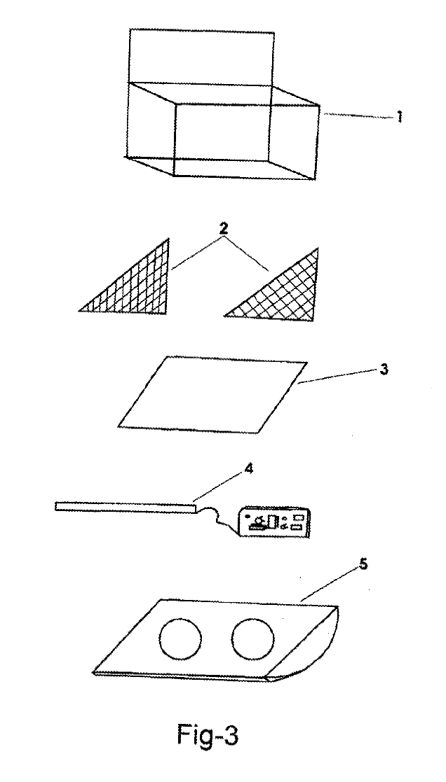

FIG. 4: the disassembled view of the engines and the metal plate

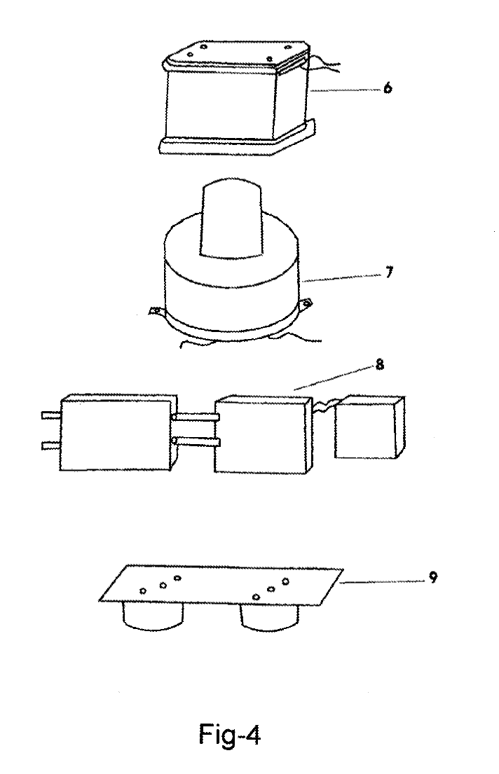

FIG. 5: the disassembled view of the battery and the lighting unit

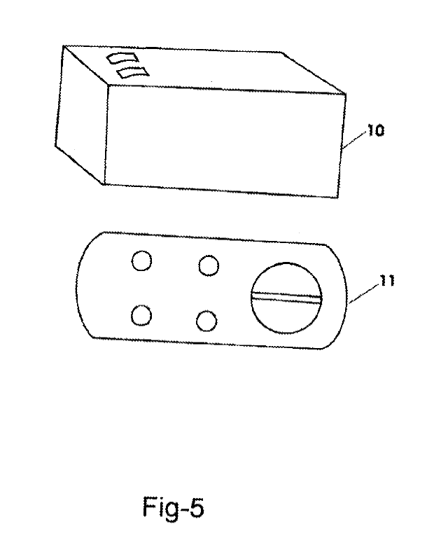

FIG. 6: geared engine view

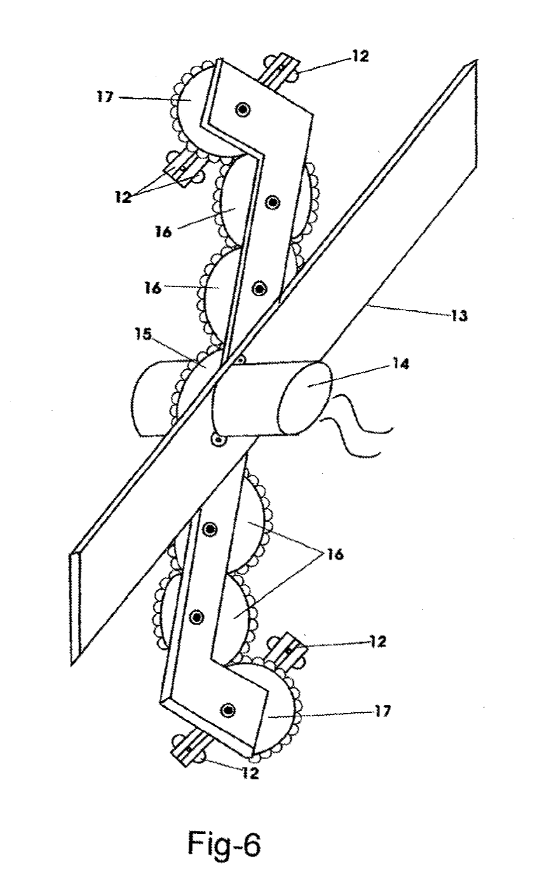

The names of the parts that are included in the figures are

1—The main box

2—The plates

3—The mirror/the reflective surface

4—The electronic circuit

5—The sot material (paper/fabric)/Teflon dry greasing product

6—The engine-1

7—The engine-2

8—The mechanism engine

9—The metal plate

10—The battery

11—The lighting unit

12—The magnets

13—The metal rod

14—The gear engine

15—The main gear-1

16—The interim gears

17—The main gear-2

18—The magnet inside the product

### DETAILED DESCRIPTION OF THE INVENTION

The invention is in respect of a detached and mobile product advertisement stand.

The main box (1) consists of the following parts; the plates (2), the mirror/the reflective surface (3), the electronic circuit (4), the soft (paper/fabric) material/Teflon dry greasing product (5), the engine-1 (6), the engine-2 (7), the mechanism engine (8), the metal plate (9), the battery (10) and the lighting unit (11) and the magnets (12), the metal rod (13) and the gear engine (14), the main gear-1 (15), the interim gears (16) and the main gear-2 (17) and the magnet inside the product (18).

The main box (1) with the condition that the inside has to be a leaning rectangle; the outside is possible to be made in every demanded shape and by using any types of materials and the front side is going to be glass or Plexiglas material so as not to block the view of the inside, and the same is then dosed, and then being covered with a film material in a lighter shade (when the rotation of the product has stopped and when the LEDs are turned off) the visual of the inside is thus being blocked. Of the inside, to the right and left walls, starting from the front top, till the back bottom, the sensitive Mirror/the reflective surface (3) is going to be installed with an angle of 45 degrees having lap joints in the shape of a square in parallel lines with the angle and thereby the visual of the mirror/the reflective surface (3) is going to be lost. The lighting of the front side of the said mirror/the reflective surface is going to be handled as follows; the electronic circuit (4) is going to be installed into the back inside part, having interchangeable colour options. With the magnets (12) that have to be symmetrical and that are mounted onto the back side of the product, the scratching of the mirror/the reflective surface (3) is going to be eliminated and the same is going to be covered with the soft (paper/fabric) material/Teflon dry grease product (5). The engine-1 (6) that both rotates the product with the front view around itself and also the engine-2 (7) that rotates the product inside the interior surroundings of the box and at the same time, while undertaking the said rotations, the mechanism engine (8) that provides for the forward and backward movements of the product; and thereby the electronic equipment has been connected to each other, all together have been connected to the metal rod (13) that stands in a parallel line with the surface having an angle of 45 degrees to the two walls of the back side of the box. At the lowermost part of the complicated engines (6, 7, 8) again in parallel lines with the surface of 45 degrees and again in touch with the said surface however having a freedom of movement of its own, in various sizes, that are possible to be adjusted with one or more intervals, onto which the magnets are being mounted, there is a metal rod (9). The energy for all of the above, is going to be provided with a battery of various powers that has been installed into the internal surface of the main box (1).

There is a remote control (14) that turns on and turns off all of the said operations, that increases the speed and decreases the speed, that arranges the operation of the engines one by one or in doubles or all of the engines at the same time, that provides the choices of colours and that provides for the lighting facilities.

With our invention, there is no requirement for the mirror/the reflecting surface (3) to be made a hole from a single point. The engine-1 (6) that rotates around itself behind the back of the mirror 7 the reflective surface the engine-2 (7) that provides for the circular rotation within the main box (1) and the mechanism engine (8) that provides for the forward and backward curved moves during the rotation in circles are used. In this manner more than one product are rotated without blocking each other and without having an intervention on the mirror/the reflective surface (3) to rotate around themselves and within the internal diameter of the main box (1). (For example: the models of the sun, the earth, the moon and the planets all together in one).

The pressure weight is being provided in equal volumes with the engine-1 (6), engine-2 (7) and the mechanism engine (8) that are connected with the metal plate (9) on which the product in front of the mirror/the reflecting surface (3) are hold with the magnets (18) on the product and the other magnets (12) that could be arranged with intervals and since the back side of the product is covered with soft (paper/fabric) material/Teflon dry grease product; the problem of giving harm or the problem of being noticed for the mirror/the reflective surface (3) is eliminated.

Alternatively, the invention provides for the use of a gear engine (14). The gear engine (14) is being operated by the main gear-1 (15) and this movement helps to rotate the interim gears (16). The main gear-1 (15) and the main gear-2 (17) by rotating the apparatus around itself using the magnets (12) on the surface; provides for a circular movement. Thereby two or more products could he rotated at the same time.

While the previous models could have been used for products that are narrow and that could be connected from a single point such as glasses, jewellery, bracelets, necklaces etc., with our invention, one or more products could be rotated without any malfunctions with the condition of the products being symmetrical.

1. A detached and mobile product advertisement stand comprises a main box, plates, a mirror/the reflective surface, an electronic circuit, a soft (paper/fabric) material/Teflon dry greasing product, a first engine, a second engine, a mechanism engine, a metal plate, a battery and a lighting unit and magnets, a metal rod and a gear engine, a first main gear, interim gears and the second main gear and the magnet inside the product.

2. The advertisement stand of claim 1, with the characteristic that it contains a mirror/reflective surface that is not required to have been made a hole on it only at a single point.

3. The advertisement stand of claim 2, wherein the mirror/the reflecting surface having the characteristic that it contains a soft (paper/fabric) surface/Teflon dry grease product that eliminates the harm to the same and the same being noticed.

4. The advertisement stand of claim 1, with the characteristic that it contains a mechanism engine that provides for the forward and backward movement in a curve with the second engine that provides for the rotation in circles inside the main box with an engine that provides for the rotation around itself and provides for the rotation around the main box and without causing damage to the mirror/the reflective surface that provides for the rotation of more than one product without blocking themselves.

5. The advertisement stand of claim 1, with the characteristic that it contains magnets that have been connected to the metal plate that are in turn connected to the engines.

6. The advertisement stand of claim 1 with the characteristic that it contains a gear engine, a first main gear, interim gears and the second main gear that provides for two or more products to rotate simultaneously as an alternative for the magnets.
